(19) United States
(12) Patent Application Publication
(10) Pub. No.: US 2009/0180147 A1
(43) Pub. Date: Jul. 16, 2009

(54) Direct Image Printing with Overlayed PDL Data

(76) Inventor: Andrew Rodney Ferlitsch, Camas (CA)

Correspondence Address: KIRTON & MCCONKIE, 1800 EAGLE GATE TOWER / 60 EAST SOUTH TEMPLE, P.O. BOX 45120, SALT LAKE CITY, UT, 84145-0120, US

(21) Appl. No.: 12/014,762

(22) Filed: Jan. 15, 2008

(51) Int. Cl. G06F 15/00

(52) U.S. Cl. 358/1.18

(57) ABSTRACT

Systems and methods for composition printing of a document that contains mixed printer-native formats are described. Each individual page may contain mixed native formats, and no print-time preprocessing is required on a host device external to the printing device. Instead, a printing device may be capable of taking as input both image-formatted data and PDL data. Proprietary tags in the image file are used to store the textual/PDL data. The image file with the embedded PDL data may be sent directly to the printer without preprocessing on the host. Any embedded PDL sequences are extracted and sent to the corresponding PDL interpreter. The image data is sent to the image interpreter. Another process then combines the processed data by overlaying the page fragment from the embedded PDL data onto the page surface generated from the image data. The new composed page is then output to the output engine.

### BACKGROUND OF THE INVENTION

1. Field of the Invention

The present invention relates to direct printing, and more particularly to direct composition printing of mixed-format files wherein the mixed formats may be combined on a single page.

2. Background and Related Art

Some printing devices, such as printers and multifunction peripheral devices (commonly known as multifunction printers or MFPs), have been developed with direct-print-related features, whereby the devices are able to print without using a standard printer driver. By way of example, some devices are now capable of directly printing portable document format (PDF) files and/or image-formatted files (e.g. tagged image file format—TIFF) without requiring that the file(s) be first converted by a printer driver into a printer-ready format. However, these devices are still limited in that they can only direct print a document if all the data in the document is of the same format and native to the printing device. Additionally, these devices are further limited in that they cannot utilize mixed formats on the same page.

One existing method of handling the printing of multiple formats is demonstrated in FIG. 1. This method requires a software product running on a computer, and can be used to compose a single document in a unified format from multiple documents of different formats. Once the single document is composed, a user can then print the composed document as a single job using the software application and a printer driver for the printer or other printing device. In this method, the user first prints each document to be part of the composition from within that document's application using a specialized printer driver that converts the document to a unified format stored in a central repository.

This method is limited in several regards. First, it does not support direct printing but requires an application and driver. In fact, this method requires an application and driver process at least twice (i.e. composition and print). Second, the method does not support mixed file formats on the same page. Third, this method requires manual operation of the software (i.e. to drag and drop files into the composer program and then select printing of the composed file).

Another existing method of providing printing of multiple formats is illustrated in FIG. 2. This is also implemented by a computer-based software product, where a user can compose a page from multiple input sources, and the input sources can, in some instances, be different file formats. The software application converts each file format into a printer control language (PCL) format and then composes and lays out the corresponding PCL page fragments onto a single page image. The single page image can then be sent to the printer for printing. While this method permits combining mixed file formats, it is still limited in that it requires that composition and conversion occur on the host computer, and therefore does not support direct printing.

In a third existing method for providing printing of multiple formats, as illustrated in FIG. 3, a print job may contain a mixed-image-formatted print stream. In this method, the printer supports a composite print job that may contain multiple image files of different formats. The printer accomplishes this by having special indicators in the print stream where each image file starts and/or ends. A preprocessing component of the printer converts each image format into a singular internal image format. Once all the individual image files are preprocessed into the unified internal image format, the unified internal image-formatted data can be processed as a single print job.

This third method is still limited in that it only supports the composition of image-formatted files (e.g. TIFF, JPEG—the Joint Photographic Experts Group-developed compressed image storage format), and is not used with printer description language (PDL) formats (e.g. PCL, Postscript (PS), PDF). Additionally, this method is limited in that it does not support mixed image formats on the same page.

### BRIEF SUMMARY OF THE INVENTION

Implementations of the present invention provide an effective and efficient means for composition printing of a document that contains mixed printer-native formats. Utilizing implementations of the present invention, a single page may be printed containing mixed native formats, and no print-time preprocessing is required on a host device external to the printing device. Instead, a printing device, such as a printer or MFP, may be capable of taking as input both image-formatted (e.g. TIFF and JPEG) data and PDL (e.g. PCL, Postscript, PDF) data.

In implementations of the invention, a user may intend to print an image file with a textual overlay. For example, a user may want to print an envelope with a logo and a mailing address. The image file may be the logo and the text may be the mailing address. In implementations of the invention, proprietary tags in the image file (e.g. in the image file directory (IFD) of a TIFF file) are used to store and/or reference the textual (or PDL) data. For example, a proprietary tag may be used to indicate a PCL sequence. The value field of the tag may point to an offset in the image file where the PCL sequence is stored.

In implementations of the invention, the image file with the embedded PDL data (TIFF file with embedded PCL sequence, for example) may be sent directly to the printer without print-time preprocessing on the host. Once the printing device has received the image file, a preprocessor of the printing device checks the image file for proprietary tags. For example, the preprocessor may check an IFD of a TIFF file to determine if there is a PDL/PCL sequence identified by one or more proprietary tags in the IFD. If so, the embedded PDL sequence corresponding to the tag(s) is extracted and sent to the corresponding PDL interpreter. The PDL interpreter then renders the PDL sequence(s) as page fragment(s)/page surface(s).

In parallel, the image data is sent to the image interpreter (i.e. TIFF data is sent to a TIFF interpreter), where it is rendered into a page surface. Processing of the embedded PDL and image data may occur concurrently or sequentially. Once the two processes are completed, another process then combines the two page images (image page surface/fragment and PDL page surface/fragment) by overlaying the page fragment from the embedded PDL data onto the page surface generated from the image data. The new composed page is then sent to the output engine of the printing device for outputting.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows an existing method for printing multiple formats as a single print job;

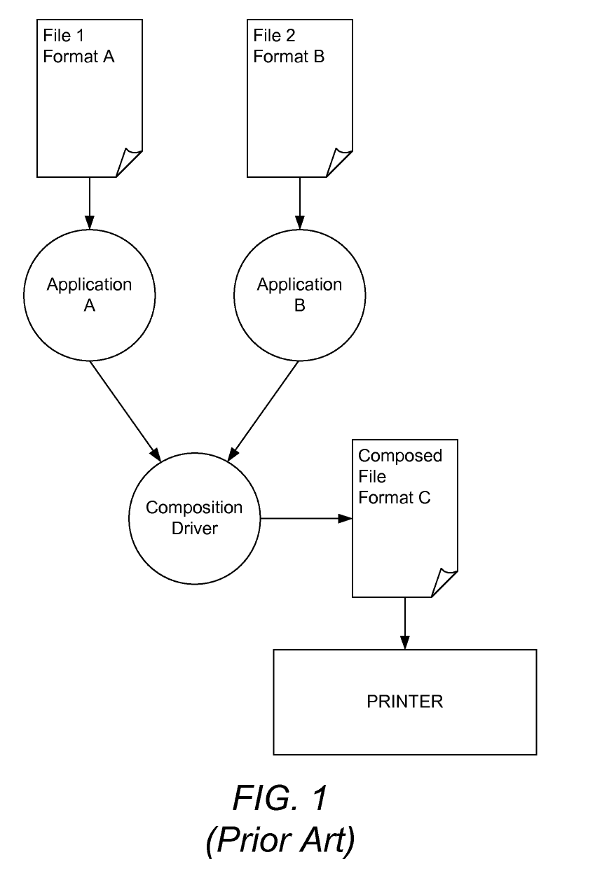

FIG. 2 shows an alternate existing method for printing multiple formats as a single print job;

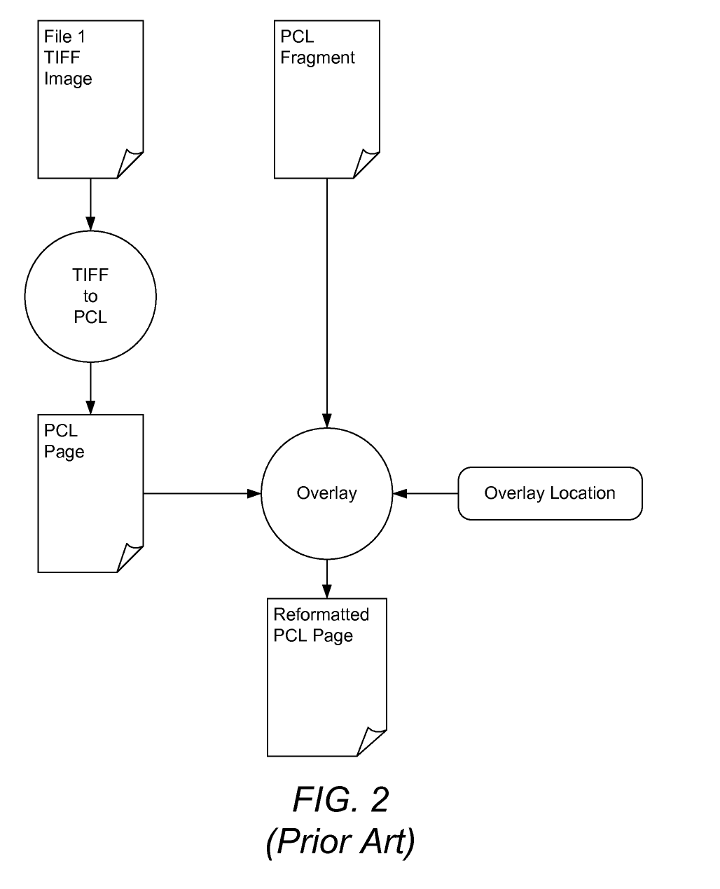

FIG. 3 shows an existing method for printing multiple image formats as a single print job;

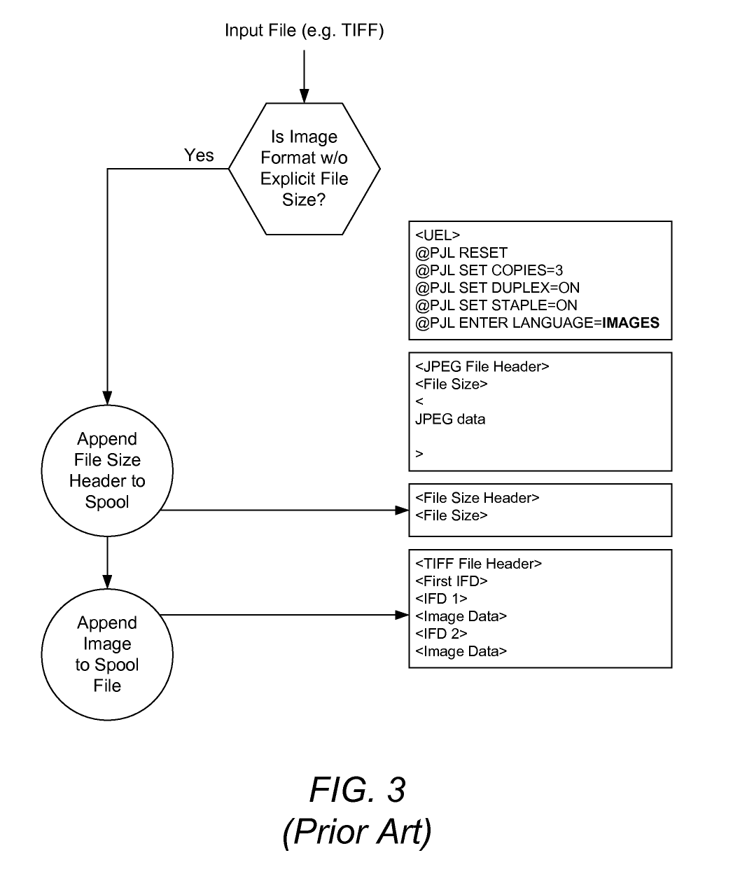

FIG. 4 illustrates a representative computer environment suitable for use with embodiments of the present invention;

FIG. 5 shows a representative networked computer environment suitable for use with embodiments of the present invention;

FIG. 6 illustrates sending multiple formats to a printing device without conversion by an intermediary printer driver or application;

FIG. 7 illustrates modifying an image file with non-image data in accordance with embodiments of the present invention;

FIG. 8 shows processing that occurs in a printing device to print multi-formatted files in accordance with embodiments of the present invention;

FIG. 9 shows additional processing accomplished by a printing device; and

FIG. 10 shows a flow chart illustrating methods and processes utilized by embodiments of the present invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the present invention provide an effective and efficient means for composition printing of a document that contains mixed printer-native formats. Utilizing embodiments of the present invention, a single page may be printed containing mixed native formats, and no print-time preprocessing is required on a host device external to the printing device. Instead, a printing device, such as a printer or MFP, may be capable of taking as input both image-formatted (e.g. TIFF and JPEG) data and PDL (e.g. PCL, Postscript, PDF) data.

In embodiments of the invention, a user may intend to print an image file with a textual overlay. For example, a user may want to print an envelope with a logo and a mailing address. The image file may be the logo and the text may be the mailing address. In embodiments of the invention, proprietary tags in the image file (e.g. in the image file directory (IFD) of a TIFF file) are used to store and/or reference the textual (or PDL) data. For example, a proprietary tag may be used to indicate a PCL sequence. The value field of the tag may point to an offset in the image file where the PCL sequence is stored.

In embodiments of the invention, the image file with the embedded PDL data (TIFF file with embedded PCL sequence, for example) may be sent directly to the printer without print-time preprocessing on the host. Once the printing device has received the image file, a preprocessor of the printing device checks the image file for proprietary tags. For example, the preprocessor may check an IFD of a TIFF file to determine if there is a PDL/PCL sequence identified by one or more proprietary tags in the IFD. If so, the embedded PDL sequence corresponding to the tag(s) is extracted and sent to the corresponding PDL interpreter. The PDL interpreter then renders the PDL sequence(s) as page fragment(s)/page surface(s).

In parallel, the image data is sent to the image interpreter (i.e. TIFF data is sent to a TIFF interpreter), where it is rendered into a page surface. Once the two processes are completed, another process then combines the two page images (image page surface/fragment and PDL page surface/fragment) by overlaying the page fragment from the embedded PDL data onto the page surface generated from the image data. The new composed page is then sent to the output engine of the printing device for outputting.

In the disclosure and in the claims, the terms “page fragment” and “page surface” shall include any size page and shall include full page fragments/surfaces and/or any portion(s) thereof.

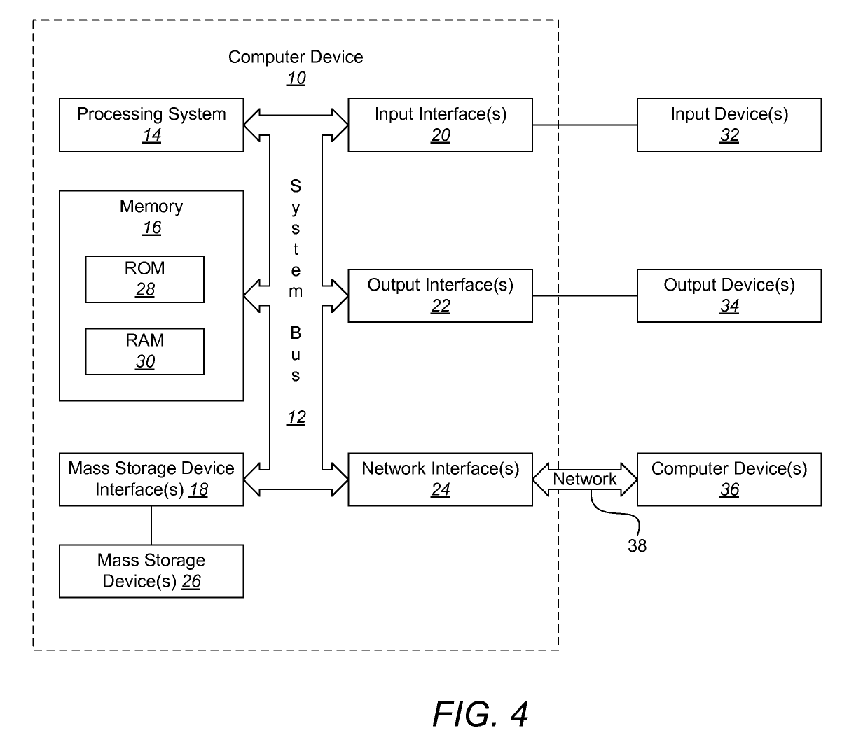

FIG. 4 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (RAM), read-only memory (ROM), programmable read-only memory (PROM), erasable programmable read-only memory (EPROM), electrically erasable programmable read-only memory (EEPROM), compact disk read-only memory (CD-ROM), digital versatile disk read-only memory (DVD-ROM), other optical disks, flash memory devices (e.g. thumb drives, memory cards, and the like), or any other device or component that is capable of providing data or executable instructions that may be accessed by a processing system, including read-only, single-write, and multiple-write devices and components.

With reference to FIG. 4, a representative system for implementing embodiments of the invention includes computer device 10, which may be a general-purpose or special-purpose computer. For example, computer device 10 may be a personal computer, a notebook computer, a personal digital assistant (PDA) or other hand-held device, a workstation, a minicomputer, a mainframe, a supercomputer, a multi-processor system, a network computer, a processor-based consumer electronic device, a smart phone, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (BIOS) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives, flash drives, memory cards, and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (USB), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (LAN) or a modem, wireless link, or other adapter for connection to a wide area network (WAN), such as the Internet, or an ad-hoc proximity network, such as a Bluetooth® network. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

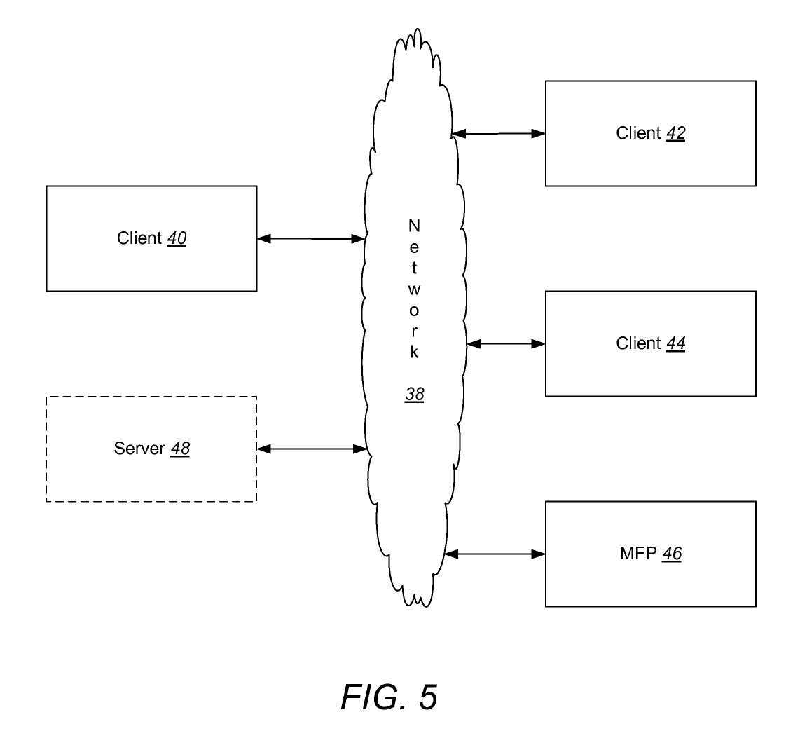

Thus, while those skilled in the art will appreciate that embodiments of the present invention may be practiced in a variety of different environments with many types of system configurations, FIG. 5 provides a representative networked system configuration that may be used in association with embodiments of the present invention. The representative system of FIG. 5 includes a computer device, illustrated as client 40, which is connected to one or more other computer devices (illustrated as client 42 and client 44) and one or more peripheral devices (illustrated as multifunctional peripheral (MFP) MFP 46) across network 38. The peripheral device(s) may include, as non-limiting examples, printing devices such as MFPs, printers, facsimile devices, filing devices, format conversion devices, publishing devices, media duplication devices, and copiers. While FIG. 5 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, ad-hoc proximity networked environments, and/or wide area networked environments, such as the Internet.

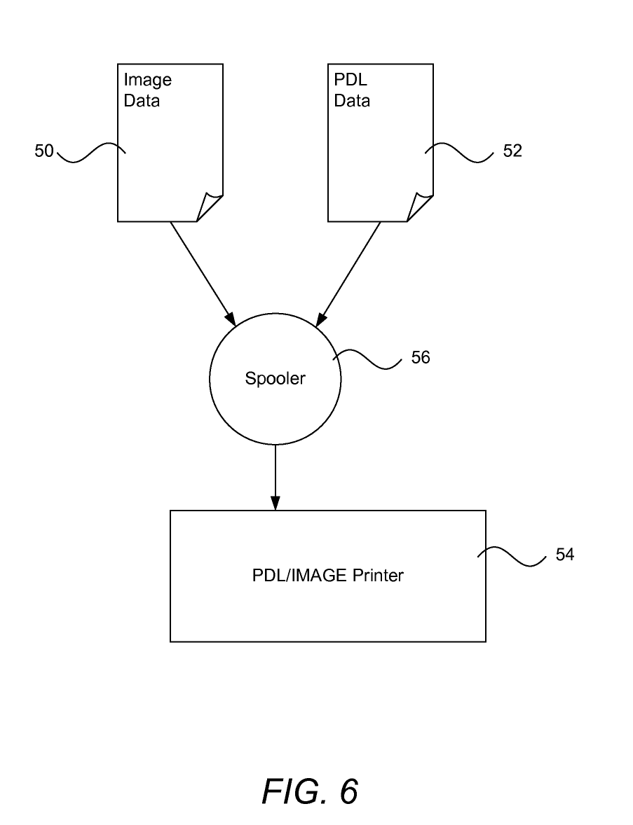

In some embodiments, the printing device may be a stand-alone device that is configured to perform the methods described herein. In such embodiments, the printing device may be capable of receiving print data from a variety of devices, including portable computing devices such as laptop or notebook computers, smart phones, PDAs, and the like, via an at-least-intermittent connection, such as a wireless connection. The printing device may also be capable of receiving print data from one or more removable storage devices, such as a USB thumb drive (e.g. “walk-up printing”). In still other embodiments, the printing device may receive print data from a locally-connected or network-connected computer. Regardless of the manner in which the printing device receives the print data, the printing device accepts both multiple-page image data 50 (e.g. TIFF) and PDL data (e.g. PCL, Postscript (PS), PDF) as input. Thus, the printing device may be considered a PDL/image printer 54. Where the printing device is at least intermittently connected to a client computer device (whether locally, remotely, or via a network), the computer device may directly submit the image/PCL data to the PDL/image printer 54 (e.g. spooled directly through spooler 56) without conversion to another format, as illustrated in FIG. 6.

Therefore, using embodiments of the invention, as described herein, a user desiring to print may print one or more pages directly, without print-time preprocessing by an application or printer driver external to the printing device. The page(s) to be printed may consist of at least an image file that represents an image to place on the page surface (e.g., envelope from logo) and a PDL (or textual stream) that represents a PDL sequence to render onto the same page surface (e.g., mailing address).

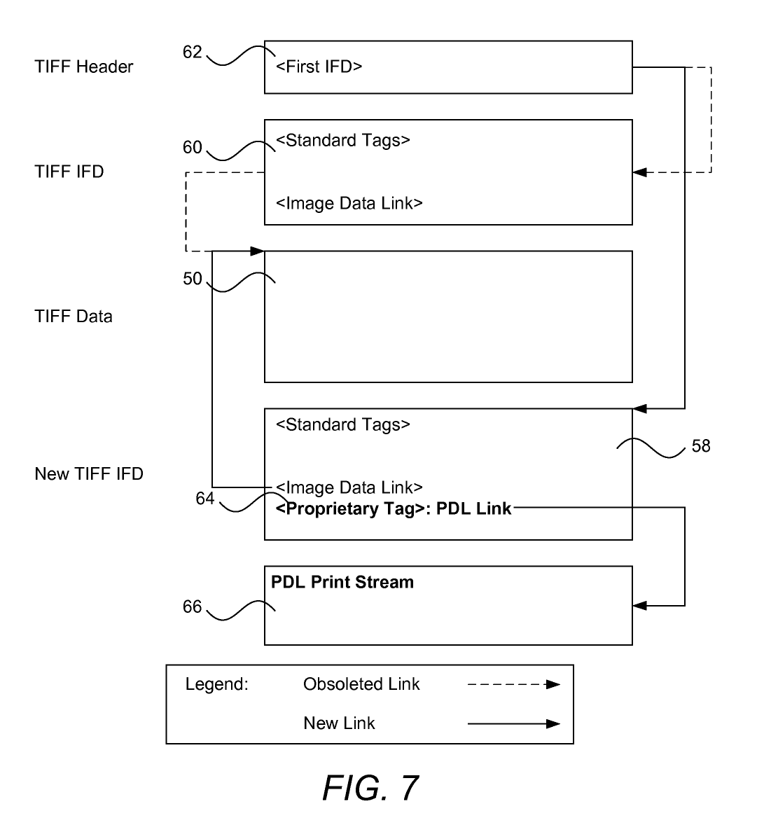

To utilize embodiments of the invention, the user may use an application that can augment an image file with non-image related data. Alternatively, an automated application and/or process may augment the image file with non-image related data. An example of such an image file format includes TIFF version 6.0. In the case of a TIFF file, the application modifies the image file as illustrated in FIG. 7 by creating a new image file directory (IFD) 58 per image. The new IFD 58 may initially be a copy of the original associated IFD 60. The image file header 62 and next IFD fields are modified to point to the new IFDs 58, instead of the original IFDs 60. The new IFDs 58 may generally be added to the end of the image file.

The new IFDs 58 have additional modifications. A new tag entry is added to the new IFD 58. The new tag entry is a proprietary tag 64 that is recognized by firmware in the printing device, and is otherwise ignored by other image processing processes. The new tag entry (proprietary tag 64) is used to point to a location in the image file of a PDL print stream 66 to embed on the same page surface as the image data 50. The PDL print stream(s) 66 may generally be added at the end of the image file, with or after the addition of the new IFD(s) 58.

The PDL print stream 66 may be provided to the application by any means, such as by: (1) predefined data stored in a file or database and selected by the user via an application control; (2) manual input of data, which the application then converts to a PDL representation; or (3) automatic input from another application (e.g., mailer application).

The TIFF image with the embedded PDL print stream may be directly sent (i.e. without conversion by an additional application or printer driver) to the printing device (e.g. MFP) for outputting. In an alternate embodiment, the TIFF image may additionally be encapsulated with print job control commands (e.g., printer job language (PJL)), which indicate how to lay out and render the encapsulated print data.

The above description with reference to FIG. 7 has been provided by way of example and not limitation. TIFF files are capable of containing multiple images in a single file, and therefore, multiple new IFDs 58 and multiple PDL print stream(s) 66 may be included in the modified multi-formatted file, corresponding to the multiple images of the TIFF files. Of course, a PDL print stream 66 may be included for only one or for fewer than all of the images of a multi-image TIFF file, and one or more other images of the TIFF file may not have PDL print streams 66 associated with them.

The term “tag entry” used in reference to TIFF files in the description above is to indicate the concept of a key field in a record identifying the purpose of the record. Therefore, in the specification and in the claims, and in relation to an arbitrary file format, whether TIFF or not, the term “tag entry” shall mean “a tag entry in a TIFF-formatted file or a parseable record in a metadata or commentary section of an otherwise arbitrary file format.”

Generally, when referring to TIFF files, the term “image file directory” may be used to refer to the concept of an image file header (per image) and also to refer to a link list of images. In file formats that do not support multiple images in a single file and therefore do not use the same linking structure utilized by TIFF files (e.g. an arbitrary image file format), the concept of a link list of images for the term “image file directory” is not applicable, and for such formats, only the concept of the image file header is applicable. Therefore, for such formats, the tag entry (i.e. the parseable record) may be located in an image file header, and the concept of the image file header (for TIFF files) is the concept utilized by embodiments of the present invention. Thus, in the specification and in the claims, the term “image file header” shall mean “an image file header, per image, in a TIFF-formatted file, or a metadata or commentary section of an otherwise arbitrary file format.”

Therefore, for an arbitrary image file format, the image file may be converted to a multi-formatted file by: (1) inserting a new tag entry (i.e. a parseable record) into the image file header (i.e. the metadata or commentary section of the image file) indicating the presence and location of a PDL print stream in the image file, such as the image file header, (2) inserting the PDL print stream into the image file (e.g. image file header) at the location specified by the new tag entry, and (3) (optionally) encapsulating print job control commands into the image file (e.g. at the image file header). One of skill in the art will readily appreciate that the steps outlined above may be reordered or done simultaneously and still fall within the described embodiments of the present invention. In other words, either or both of the PDL print stream and the print job control commands may be added to the image file header before the new tag entry is inserted or may be done simultaneously with the insertion of the new tag entry.

Once the MFP (or other printing device) receives the TIFF image with the embedded PDL data, the MFP determines the format of the print stream and sends it to the appropriate interpreter. Since the print stream is an image format, the print data is directed to the corresponding image interpreter (e.g., TIFF interpreter).

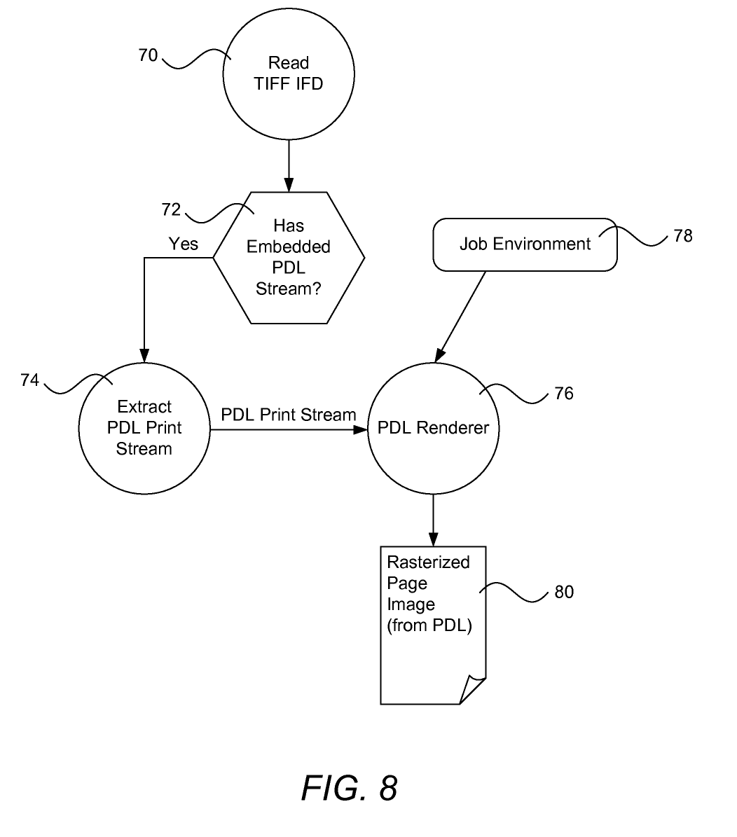

Illustrative processing performed by the corresponding image interpreter is shown in FIG. 8. For each image in the image data, the image interpreter first processes the associated image file directory (i.e., new IFD 58) at step 70. The image interpreter checks if there is a reference to an embedded PDL print stream 66 in the IFD at decision block 72. If not, the image data is processed normally. However, if there is a reference to an embedded PDL print stream 66, the image interpreter extracts the embedded PDL print stream 66 at step 74. The extracted PDL print stream 66 is then sent to the corresponding PDL interpreter (e.g., PCL, PS, PDF) at step 76, which then renders the PDL print data, according to the current job environment 78, into a page fragment (which may be a whole page) image 80. The rendered page fragment 80 is then returned back to the image interpreter.

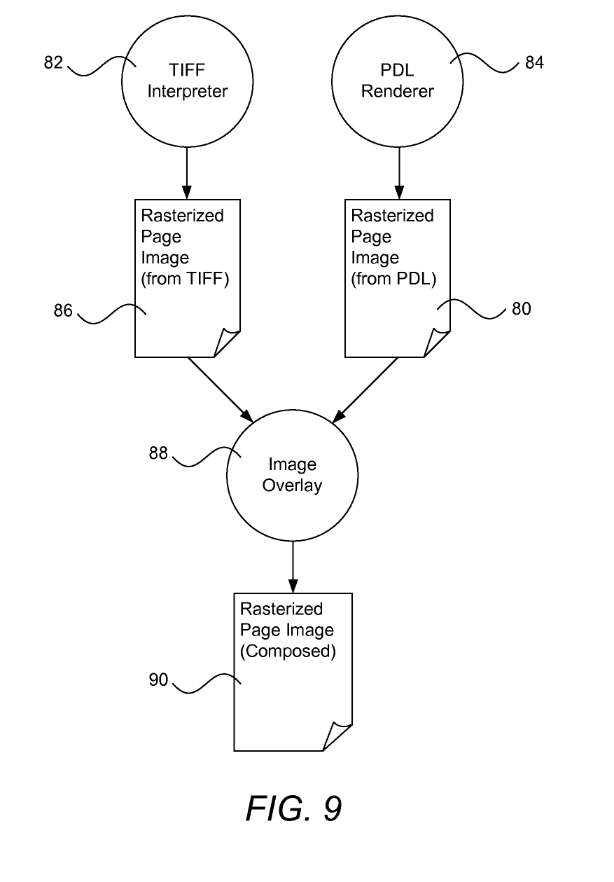

As illustrated in FIG. 9, the image interpreter (e.g. TIFF interpreter 82) renders the image data onto a page surface (e.g. rasterized page from TIFF 86) either in parallel with the rendering performed by the PDL interpreter (e.g. PDL renderer 84) or once the image interpreter receives the rendered PDL-based page fragment 80 from the PDL interpreter. The PDL page fragment 80 and the image page surface 86 are then merged via an image overlay 88 to form a finalized composed page image 90. The merge may occur as an overlay function, where the page fragment 80 is overlaid on the page surface 86 generated by the image data, or the merge may occur as any other merge function. Where the merge occurs as an overlay function, the overlay function may occur by any method, such as: (1) the page fragment 80 is overlaid at a predetermined location; (2) the page fragment 80 is overlaid at a location specified by the PDL print stream; and (3) the page fragment 80 is overlaid at a location specified by another proprietary tag in the image file. As has been stated previously, the page fragment 80 and the image page surface 86 may be whole page images. The overlay function may occur as a transparency or may be opaque.

Once the composed finalized page image 90 has been generated, it may be sent to the output engine for outputting. In this way, mixed image formats may be printed on the same page without requiring special processing at the time of printing by a printer driver or other application external to the printing device.

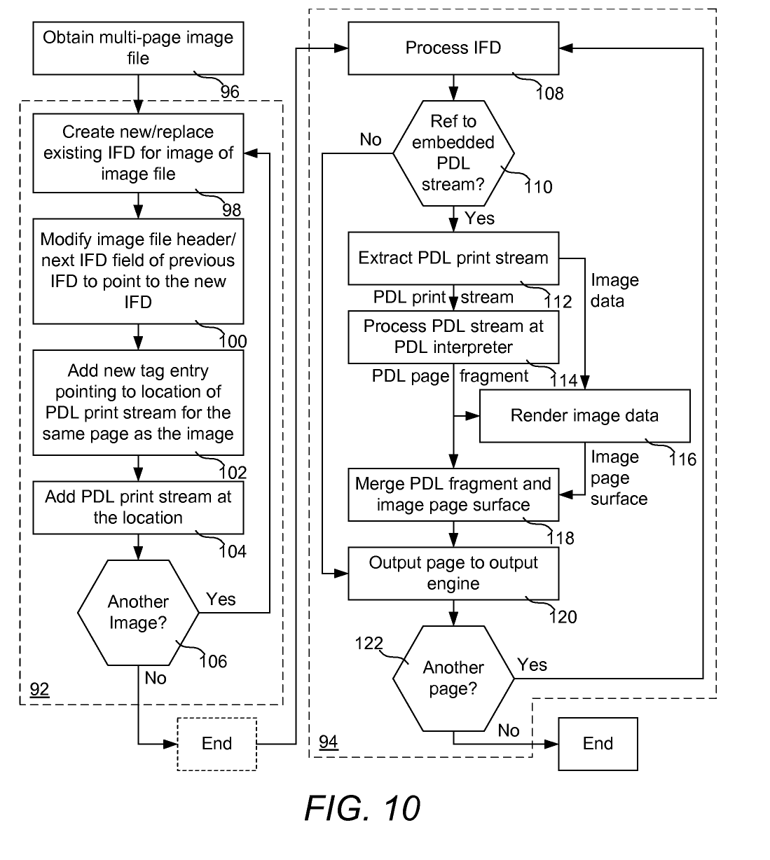

FIG. 10 shows a flow chart illustrative of methods in accordance with embodiments of the invention. In FIG. 10, area 92 is representative of processing of a representative image file to embed PDL print stream data into the image file, and is processing that may occur on a computer device at any time prior to printing of the image file. The process within area 94 is representative of processing that occurs on the printing device at the time of printing the image file. The processing occurring within areas 92 and 94 may occur separately in both time and place. By way of example and not limitation, an image file may be processed according to the area 92 by a first user and then distributed to one or more additional users for printing by the additional user(s) at a time and location chosen by the additional user(s).

As another example, the image file may be processed according to area 92, and then saved for later printing. At some point, the saved file may be transferred or located onto a removable storage media, such as a USB thumb drive or media card, that may be printed at a printer, MFP, or other printing device as a “walk-up” print job. In this way, the user would not need to utilize a separate program or printer driver to print the multi-format image file. Those of skill in the art will readily appreciate additional advantages and applications of the embodiments of the invention described herein.

Processing begins at step 96, where a user obtains an image file. The image file may already be processed in accordance with embodiments of the present invention, and if so, execution may skip/proceed to step 108, or the existing file may be modified to change the image and/or PDL data associated with the multi-format file.

Otherwise, execution proceeds to step 98 for the first image of the image file to have PDL data associated with the image, where a new image file directory is generated for the image of the image file. The new image file directory may coexist with the previously-utilized image file directory or it may replace the existing image file directory. Replacement, if utilized, may be merely conceptual replacement, in that the existing image file directory may simply be utilized and modified as described herein. In any event, execution proceeds to step 100, where the image file header (in the case of the first image of the image file) or the next image file directory field of the previous image file directory (in the case of a subsequent image of the image file) is modified to point to the new image file directory, if necessary. Execution then proceeds to step 102, where a new tag entry pointing to the location of the PDL print stream for the same page as the current image being processed is added to the new image file directory. The new PDL print stream is then added at the location specified by the tag at step 104. As set forth above, the location for the new image file directory and the PDL print stream may be at the end of the existing image file.

Although not specifically illustrated in FIG. 10, additional processing may be performed to encapsulate print job control commands (e.g. PJL) to indicate how to layout and render the encapsulated print data, as set forth above. Thereafter, at decision block 106, a determination is made whether the last-processed image of the image file is the last image to be processed of the image file or whether another image is to be processed. If another image remains in the image file to have an associated PDL print stream associated with it, execution returns to step 98. Otherwise, execution may end when immediate printing is not desired or may proceed to the first step of printing, step 108.

During printing, the image file (which is now multi-format) is received at the printing device (e.g. the printer or MFP) without being processed by an additional application or printer driver external to the printing device. The printing device directs the image file to the corresponding image interpreter of the printing device. The printing device (i.e. the printing device's image interpreter) processes the first page image file directory of the image file at step 108. Execution proceeds to decision block 110, where it is determined whether the image file directory contains a reference to an embedded PDL stream. If the image file directory does not contain a reference to an embedded PDL stream, execution proceeds to step 120, where the associated image page is output to the printing device's output engine. If the image file directory contains a reference to an embedded PDL stream, execution proceeds to step 112, where the associated PDL stream is extracted from the file. The PDL stream is sent to the PDL interpreter, where it is processed into a PDL page fragment at step 114. The PDL interpreter then returns the PDL page fragment (which may be an entire rasterized page image) to the image interpreter.

The image interpreter, either upon receiving the processed PDL page fragment or in parallel with the processing performed by the PDL interpreter, renders the image data at step 116 into an image page surface. The PDL page fragment and the image page surface are merged at step 118, as described herein. The merged page is then sent to the output engine at step 120 for printing. Execution then proceeds to decision block 122, where a determination is made as to whether the image file contains another page to be printed. If so, execution returns to step 108. If not, printing is complete and execution ends.

Thus, the described embodiments of the present invention provide an effective and efficient means for composition printing of a document that contains mixed printer native formats. Utilizing embodiments of the present invention, a single page may contain mixed native formats, and no print-time preprocessing is required on a host device external to the printing device. Instead, a printing device, such as a printer or MFP may be capable of taking as input and printing on a single page both image-formatted data and PDL data.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method for direct printing of mixed-format files comprising:
receiving a mixed-format file containing image data and page description language (PDL) data at a printing device;
extracting a first PDL sequence from the mixed-format file at the printing device;
rendering the first PDL sequence as a first page fragment at the printing device;
rendering a first portion of the image data into a first page surface at the printing device;
combining the first page fragment and the first page surface into a first composed page at the printing device; and
outputting the first composed page.

2. A method as recited in claim 1, further comprising:
locating the first PDL sequence in the mixed-format file;
sending the first PDL sequence to a PDL interpreter of the printing device; and
sending the image data to an image interpreter of the printing device.

3. A method as recited in claim 1, wherein the mixed-format file is received at the printing device from a computer device.

4. A method as recited in claim 1, wherein the mixed-format file is received at the printing device from a removable storage device.

5. A method as recited in claim 1, further comprising processing an image file to create the mixed-format file.

6. A method as recited in claim 5, wherein processing the image file to create the mixed-format file comprises:
adding a new tag entry into an image file header of the image file pointing to a location of the image file where a PDL print stream is to be added to the image file; and
adding the PDL print stream to the image file at the location identified by the new tag entry.

7. A method as recited in claim 6, wherein processing the image file to create the mixed-format file further comprises:
creating a new image file header for an image of the image file, wherein the new image file header is the image file header to which the new tag entry is added;
modifying one of a file header and a next image file header field of a previous image file header to point to the new image file directory.

8. A method as recited in claim 7, wherein creating a new image file header comprises one of copying an existing image file header and replacing the existing image file directory.

9. A method as recited in claim 6, wherein processing the image file to create the mixed-format file further comprises encapsulating print job control commands indicating how to lay out and render the image data and the PDL data.

10. A method as recited in claim 1, further comprising:
extracting a second PDL sequence from the mixed-format file at the printing device;
rendering the second PDL sequence as a second page fragment at the printing device;
rendering a second portion of the image data into a second page surface at the printing device;
combining the second page fragment and the second page surface into a second composed page at the printing device; and
outputting the second composed page.

11. A printing system for direct printing of mixed-format files comprising:
a mixed-format file comprising:
an image file directory;
image data;
a tag entry of the image file header pointing to a location in the mixed-format file where a PDL print stream is embedded; and
the PDL print stream; and
a printing device configured to receive the mixed-format file and to composition print the mixed format file without print-time preprocessing on a host computer device comprising:
a PDL interpreter configured to render the PDL print stream into a page fragment;
an output engine; and
an image interpreter communicatively coupled to the PDL interpreter and the output engine, wherein the image interpreter is configured to:
determine when there is the tag entry in the image file directory;
extract the PDL print stream identified by the tag entry;
pass the PDL print stream to the PDL interpreter;
render the image data into a page surface;
receive the page fragment from the PDL interpreter;
merge the page fragment and the page surface into a composed page; and
output the composed page to the output engine.

12. A printing system as recited in claim 11, wherein the image data is in one of tagged image file format (TIFF) and Joint Photographic Experts Group (JPEG).

13. A printing system as recited in claim 11, wherein the printing device further comprises an input interface configured to receive the mixed-format file and to pass the mixed-format file to the image interpreter.

14. A printing system as recited in claim 13, wherein the input interface comprises one of:
a universal serial bus (USB) port configured to receive and communicatively couple to a USB mass storage device;
a wireless network interface for wirelessly connecting to a computer device;
a port for physically connecting to a computer device; and
a wired network interface for physically connecting to a network connected to a computer device.

15. A computer-readable medium storing a computer program product for implementing a method for direct printing of mixed-format files, the computer program product comprising computer program code means for:
receiving a mixed-format file containing image data and page description language (PDL) data at a printing device;
extracting a first PDL sequence from the mixed-format file at the printing device;
rendering the first PDL sequence as a first page fragment at the printing device;
rendering a first portion of the image data into a first page surface at the printing device;
combining the first page fragment and the first page surface into a first composed page at the printing device; and
outputting the first composed page.

16. A computer-readable medium as recited in claim 15, wherein the computer program product further comprises computer program code means for:
extracting a second PDL sequence from the mixed-format file at the printing device;
rendering the second PDL sequence as a second page fragment at the printing device;
rendering a second portion of the image data into a second page surface at the printing device;
combining the second page fragment and the second page surface into a second composed page at the printing device; and
outputting the second composed page.

17. A computer-readable medium as recited in claim 15, wherein the computer program product further comprises computer program code means for:
locating the first PDL sequence in the mixed-format file;
sending the first PDL sequence to a PDL interpreter of the printing device; and
sending the image data to an image interpreter of the printing device.

18. A computer-readable medium storing a computer program product for implementing a method for modifying an image file into a mixed-format file for direct printing by a printing device without print-time preprocessing on a host computer device, the computer program product comprising computer program code means for:
adding a new tag entry into an image file header of the image file pointing to a location of the image file where a page description language (PDL) print stream is to be added to the image file; and
adding the PDL print stream to the image file at the location identified by the new tag entry.

19. A computer-readable medium as recited in claim 18, wherein the computer program product further comprises computer program code means for:
creating a new image file header for an image of the image file, wherein the new image file header is the image file header to which the new tag entry is added;
modifying one of a file header and a next image file header field of a previous image file header to point to the new image file directory.

20. A computer-readable medium as recited in claim 19, wherein creating a new image file header comprises one of copying an existing image file header and replacing the existing image file directory.

21. A computer-readable medium as recited in claim 18, wherein the computer program product further comprises computer program code means for encapsulating print job control commands indicating how to lay out and render image data and PDL data of the mixed-format file.

22. A computer-readable medium as recited in claim 18, wherein the new tag entry is a parseable record and wherein the image file header is one of:
a metadata section of the image file; and
a commentary section of the image file.
